(19) United States
(12) Patent Application Publication
(10) Pub. No.: US 2020/0114701 A1
(43) Pub. Date: Apr. 16, 2020

(54) PNEUMATIC TIRE

(71) Applicant: The Goodyear Tire & Rubber Company, Akron, OH (US)

(72) Inventors: Paul WELBES, Schrondweiler (LU); Jaroslaw Antoni KOTWICA, Rollingen (LU)

(21) Appl. No.: 16/161,629

(22) Filed: Oct. 16, 2018

(51) Int. Cl. B60C 15/00; B60C 9/02; B60C 13/00

(52) U.S. Cl. CPC B60C 15/0009; B60C 13/002; B60C 9/02

(57) ABSTRACT

A tire includes a tread, a sidewall extending from one edge of the tread approximately in a radially inward direction to a bead structure, and a carcass extending along an axially inner side of the sidewall to the bead structure. The carcass includes a first ply and a second ply extending radially inward from the sidewall to a terminal end directly adjacent the bead structure. The bead structure includes a circumferentially extending bead core axially inward of the sidewall, a chafer extending radially inward toward the bead core, an apex abutting the bead core, and an inner stiffener member disposed between the first ply and the apex, the inner stiffener member extending radially outward from a location proximate the bead core to a location radially outward from the apex.

### FIELD OF THE INVENTION

The present invention relates to a pneumatic tire and, more specifically, to a pneumatic bead and sidewall construction.

### BACKGROUND OF THE INVENTION

A pair of beads is provided for a conventional tire. A carcass is set to bridge the beads on both sides. A bead has a core and an apex extending from the core in a radially outward direction. One or more carcass plies of the carcass is usually turned up around the bead core from the axially inner side toward the outer side. Due to such a structure, a carcass ply may be divided into a main portion and a turn-up portion. The bead portion of a tire may be fixed onto a rim.

### SUMMARY OF THE INVENTION

A first example tire in accordance with the present invention includes a tread, a sidewall extending from one edge of the tread approximately in a radially inward direction to a bead structure, and a carcass extending along an axially inner side of the sidewall to the bead structure. The carcass includes a first ply and a second ply extending radially inward from the sidewall to a terminal end directly adjacent the bead structure. The bead structure includes a circumferentially extending bead core axially inward of the sidewall, a chafer extending radially inward toward the bead core, an apex abutting the bead core, and an inner stiffener member disposed between the first ply and the apex, the inner stiffener member extending radially outward from a location proximate the bead core to a location radially outward from the apex.

According to another aspect of the first example tire, the bead structure further includes a second chafer proximate the bead core.

According to still another aspect of the first example tire, the apex is positioned on a radially inner side of the sidewall.

According to yet another aspect of the first example tire, the apex is positioned on an axially outer side of the bead core.

According to still another aspect of the first example tire, the bead structure further includes a second chafer abutting a rim on which the tire is mounted.

According to yet another aspect of the first example tire, the bead structure further includes a second apex disposed adjacent a second chafer apex on an axially outer side of the second ply.

According to still another aspect of the first example tire, the bead structure further includes a second apex extending from a radially outer side of the bead core along the second ply in a radially outward direction to a location adjacent both the sidewall and a second chafer.

According to yet another aspect of the first example tire, the apex contains a reinforcing material.

According to still another aspect of the first example tire, the chafer contains a reinforcing material.

According to yet another aspect of the first example tire, the inner stiffener member contains a reinforcing material.

A second example tire in accordance with the present invention includes a tread, a sidewall extending from one edge of the tread approximately in a radially inward direction to a bead structure, and a carcass extending along an axially inner side of the sidewall to the bead structure. The carcass includes a first ply and a second ply. The bead structure includes a circumferentially extending bead core axially inward of the sidewall, a chafer extending radially inward toward the bead core, an apex abutting a radially upper surface of the bead core, and an inner stiffener member disposed partially between the first ply and the apex. The inner stiffener member also is partially disposed between one portion of the first ply and another portion of the first ply.

According to another aspect of the second example tire, the bead structure further includes a second chafer adjacent the bead core.

According to still another aspect of the second example tire, the apex is positioned on a radially inner side of the sidewall.

According to yet another aspect of the second example tire, the apex is positioned on an axially outer side of the bead core.

According to still another aspect of the second example tire, the bead structure further includes a second chafer abutting a rim on which the tire is mounted.

A third example tire in accordance with the present invention includes a tread, a sidewall extending from one edge of the tread approximately in a radially inward direction to a bead structure, and a carcass extending along an axially inner side of the sidewall to the bead structure. The carcass includes a first ply and a second ply extending radially inward from the sidewall to a terminal end directly adjacent the bead structure. The bead structure includes a circumferentially extending bead core axially inward of the sidewall, a chafer extending radially inward toward the bead core, a first apex abutting the bead core, an inner stiffener member disposed between the first ply and the first apex, and a second apex disposed between the second ply and the chafer.

According to another aspect of the third example tire, the second apex is disposed adjacent the chafer on an axially outer side of the second ply.

According to still another aspect of the third example tire, the second apex member extends from a radially outer side of the bead core along the second ply in a radially outward direction to a location adjacent both the sidewall and the chafer.

According to yet another aspect of the third example tire, the first apex and the second apex both contain a reinforcing material.

According to still another aspect of the third example tire, the inner stiffener member contains a reinforcing material.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an enlarged cross-sectional view showing part of a tire in accordance with the present invention.

### DETAILED DESCRIPTION OF EXAMPLES OF THE PRESENT INVENTION

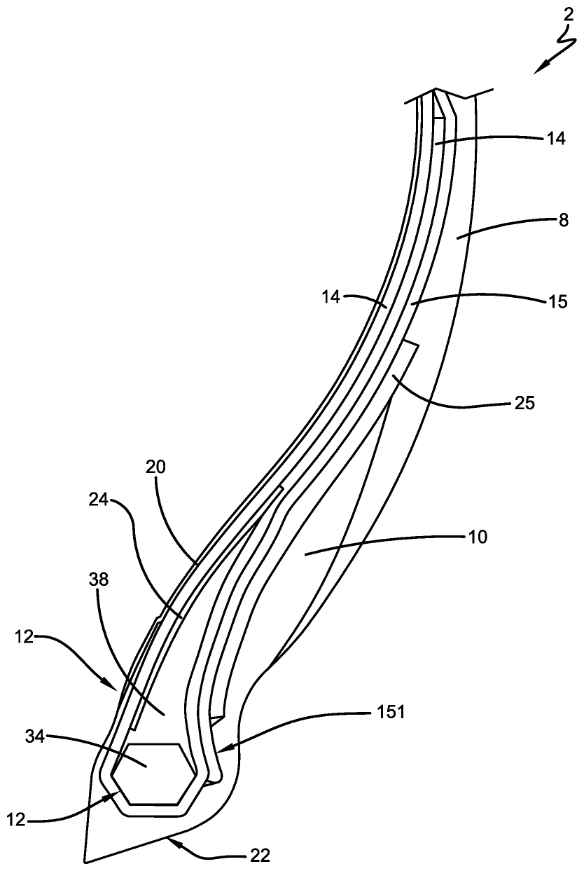

The examples will be described below with reference to the accompanying drawing (FIG. 1), wherein like reference numerals designate corresponding or identical elements throughout the drawing. Vertical directions may correspond to radial directions of the pneumatic or non-pneumatic tire 2, lateral directions may correspond to axial directions of the tire, and directions perpendicular to the drawing sheet of FIG. 1 may be circumferential directions of the tire. A similar tire is described in U.S. Pat. No. 9,931,895, herein incorporated by reference, in its entirety.

The tire 2 may include a tread (not shown), a sidewall 8, a carcass with a first ply 14 and a second ply 15, a belt (not shown), an inner liner 20, and two bead structures 12 (one shown), each including a bead core 34, a first chafer 22, a second chafer 10, a first apex 38, an inner stiffener 24, and a second apex 25. The tread may be convex in a radially outward direction. The tread may form a tread surface, which may contact a road surface. Grooves may be formed in the tread and thereby shape a tread pattern. The tread may have a base layer and a radially outer cap layer. The cap layer may be laminated on to the base layer. The base layer may have a crosslinked rubber with excellent adhesiveness. The typical rubber material for the base layer may be natural rubber. The cap layer may have a crosslinked rubber with excellent wear resistance, heat resistance, and/or grip capability.

A sidewall 8 may extend from the edge of the tread in an approximately radially inward direction. The radially outer edge of sidewall 8 may be bonded to the tread. The radially inner edge of sidewall 8 may be bonded to a second chafer 10. The sidewall 8 may be constructed of a crosslinked rubber with excellent cut resistance and wear resistance. The sidewall 8 and second chafer 10 may prevent damage to the carcass plies 14, 15. The second chafer 10 may be positioned on the radially inner side of the sidewall 8. The second chafer 10 may be positioned on the axially outer side of the bead structure 12 and the second carcass ply 15. The second chafer 10 may also abut a flange of a rim (not shown) on which the tire 2 is mounted.

The bead structure 12 may be positioned on the axially inner side of the second chafer 10 and the first carcass ply 14. The bead 12 may be formed with a core 34 and a second apex 38. The bead core 34 may be ring-shaped and include a wound non-stretchable wire. A typical material for the wire may be steel. The second apex 38 may extend from the bead core 34 in a radially outward direction. The second apex 38 may taper as it extends in a radially outward direction between portions of the first carcass ply 14.

The second chafer 10 and/or the second apex 38 may be a crosslinked rubber composition, such as a diene-based rubber. Specific examples of diene-based rubbers are natural rubber (NR), polyisoprene (IR), polybutadiene (BR), acrylonitrile-butadiene copolymer (NBR) and polychloroprene (CR). These rubbers may also be used in combination of two or more for the second apex 38.

The rubber composition for forming second chafer 10 and/or the second apex 38 may contain a reinforcing material, such as carbon black. Examples of carbon blacks may be a carbon black with fast extruding furnace (FEF), general purpose furnace (GPF), high abrasion furnace (HAF), super abrasion furnace (SAF), and intermediate SAF (ISAF) grades.

An inner liner 20 may be disposed on the inner side of the first carcass ply 14. The inner liner 20 may be bonded to the inner surface of the first carcass ply 14. The inner liner 20 may be a crosslinked rubber with excellent air shielding properties. Example base rubbers for the inner liner 20 may be butyl rubber or halogenated butyl rubber. The inner liner 20 may thus retain the inflation pressure of tire 2.

A first chafer 22 may be disposed adjacent the bead 12. When the tire 2 is mounted on a rim, the first chafer 22 may abut the rim and thereby protect the bead structure 12. The first chafer 22 may be integrated with the second chafer 10.

The inner stiffener 24 may be disposed on an axially outer side of the first carcass ply 14. The inner stiffener 24 may extend generally from the radially outer side of the bead core 38 along the first carcass ply 14 in an approximately radially outward direction to adjacent a location where the first carcass ply 14 rejoins itself.

The second apex 25 may be disposed adjacent the second chafer 10 on an axially outer side of the second carcass ply 15. The second apex 25 may extend generally from the radially outer side of the bead core 34 along the second carcass ply 15 in an approximately radially outward direction to adjacent a location where the sidewall 8 and the second chafer 10 join.

The inner stiffener and second apex 24, 25 may include a cross-linked rubber composition such as a diene-based rubber. Examples of such diene-based rubbers may be natural rubber (NR), polyisoprene (IR), polybutadiene (BR), acrylonitrile-butadiene copolymer (NBR), and polychloroprene (CR) rubbers. These rubbers may also be used in combination of two or more for the inner stiffener 24 and second apex 25.

The rubber composition for forming inside stiffener and second apex 24, 25 may contain a reinforcing material, such as carbon black. Examples of carbon blacks may be a carbon black with fast extruding furnace (FEF), general purpose furnace (GPF), high abrasion furnace (HAF), super abrasion furnace (SAF), and intermediate SAF (ISAF) grades.

In accordance with the present invention, the second carcass ply 15 may extend radially inward from the tread to a location radially adjacent the bead core 34 (FIG. 1). The second carcass ply 15 may further extend axially outward of all portions of the first carcass ply 14 proximate the bead structure 12. Combined with the inner stiffener 24 and/or the second apex 25, such a second carcass ply 15 may provide acceptable durability without altering the other components (e.g., bead core 34, first chafer 22, second chafer 10, second apex 38, etc.) of the bead structure 12. Such a construction thus may reduce material cost, weight, and rolling resistance of the tire 2.

One example tire 2 in accordance with the present invention may include a tread, a sidewall 8 extending from one edge of the tread approximately in a radially inward direction to a bead structure 12, and a carcass 14, 15 extending along an axially inner side of the sidewall to the bead structure 12. The carcass may include a first ply 14 and a second ply 15. The second ply 15 may extend radially inward from the sidewall to a terminal end 151 directly adjacent the bead structure 12. The bead structure 12 may include a circumferentially extending bead core 34 axially inward of the sidewall 8, a chafer 10 extending radially inward toward the bead core 34, an apex 38 abutting the bead core 34, and an inner stiffener member 24 disposed between the first ply 14 and the apex 38. The inner stiffener member 24 may extend radially outward from a location proximate the bead core 34 to a location radially outward from the apex 38 (FIG. 1).

Another example tire 2 in accordance with the present invention may include a tread, a sidewall 8 extending from one edge of the tread approximately in a radially inward direction to a bead structure 12, and a carcass 14, 15 extending along an axially inner side of the sidewall to the bead structure 12. The carcass may include a first ply 14 and a second ply 15. The bead structure 12 may include a circumferentially extending bead core 34 axially inward of the sidewall 8, a chafer 10 extending radially inward toward the bead core 34, an apex 38 abutting a radially upper surface of the bead core 34, and an inner stiffener member 24 disposed partially between the first ply 14 and the apex 38. The inner stiffener member 24 may also be partially disposed between one portion of the first ply 14 and another portion of the first ply (FIG. 1).

Still another example tire 2 in accordance with the present invention may include a tread, a sidewall 8 extending from one edge of the tread approximately in a radially inward direction to a bead structure 12, and a carcass 14, 15 extending along an axially inner side of the sidewall to the bead structure 12. The carcass may include a first ply 14 and a second ply 15. The second ply 15 may extend radially inward from the sidewall to a terminal end 151 directly adjacent the bead structure 12. The bead structure 12 may include a circumferentially extending bead core 34 axially inward of the sidewall 8, a chafer 10 extending radially inward toward the bead core 34, a first apex 38 abutting the bead core 34, an inner stiffener member 24 disposed between the first ply 14 and the first apex 38, and a second apex 25 disposed between the second ply 15 and the chafer 10 (FIG. 1).

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements. Numerous modifications and variations of the present invention are possible in light of the above teachings. It is therefore to be understood that within the scope of the appended claims, the present invention may be practiced otherwise than as specifically described herein.

What is claimed:

1. A tire comprising:
a tread;
a sidewall extending from one edge of the tread approximately in a radially inward direction to a bead structure; and
a carcass extending along an axially inner side of the sidewall to the bead structure, the carcass includes a first ply and a second ply extending radially inward from the sidewall to a terminal end directly adjacent the bead structure, the bead structure includes a circumferentially extending bead core axially inward of the sidewall, a chafer extending radially inward toward the bead core, an apex abutting the bead core, and an inner stiffener member disposed between the first ply and the apex, the inner stiffener member extending radially outward from a location proximate the bead core to a location radially outward from the apex.

2. The tire as set forth in claim 1 wherein the bead structure further includes a second chafer proximate the bead core.

3. The tire as set forth in claim 1 wherein the apex is positioned on a radially inner side of the sidewall.

4. The tire as set forth in claim 1 wherein the apex is positioned on an axially outer side of the bead core.

5. The tire as set forth in claim 1 wherein the bead structure further includes a second chafer abutting a rim on which the tire is mounted.

6. The tire as set forth in claim 1 wherein the bead structure further includes a second apex disposed adjacent a second chafer apex on an axially outer side of the second ply.

7. The tire as set forth in claim 1 wherein the bead structure further includes a second apex extending from a radially outer side of the bead core along the second ply in a radially outward direction to a location adjacent both the sidewall and a second chafer.

8. The tire as set forth in claim 1 wherein the apex contains a reinforcing material.

9. The tire as set forth in claim 1 wherein the chafer contains a reinforcing material.

10. The tire as set forth in claim 1 wherein the inner stiffener member contains a reinforcing material.

11. A tire comprising:
a tread;
a sidewall extending from one edge of the tread approximately in a radially inward direction to a bead structure; and
a carcass extending along an axially inner side of the sidewall to the bead structure, the carcass includes a first ply and a second ply, the bead structure includes a circumferentially extending bead core axially inward of the sidewall, a chafer extending radially inward toward the bead core, an apex abutting a radially upper surface of the bead core, and an inner stiffener member disposed partially between the first ply and the apex, the inner stiffener member also is partially disposed between one portion of the first ply and another portion of the first ply.

12. The tire as set forth in claim 11 wherein the bead structure further includes a second chafer adjacent the bead core.

13. The tire as set forth in claim 11 wherein the apex is positioned on a radially inner side of the sidewall.

14. The tire as set forth in claim 11 wherein the apex is positioned on an axially outer side of the bead core.

15. The tire as set forth in claim 11 wherein the bead structure further includes a second chafer abutting a rim on which the tire is mounted.

16. A tire comprising:
a tread;
a sidewall extending from one edge of the tread approximately in a radially inward direction to a bead structure; and
a carcass extending along an axially inner side of the sidewall to the bead structure, the carcass includes a first ply and a second ply extending radially inward from the sidewall to a terminal end directly adjacent the bead structure, the bead structure includes a circumferentially extending bead core axially inward of the sidewall, a chafer extending radially inward toward the bead core, a first apex abutting the bead core, an inner stiffener member disposed between the first ply and the first apex, and a second apex disposed between the second ply and the chafer.

17. The tire as set forth in claim 16 wherein the second apex is disposed adjacent the chafer on an axially outer side of the second ply.

18. The tire as set forth in claim 16 wherein the second apex member extends from a radially outer side of the bead core along the second ply in a radially outward direction to a location adjacent both the sidewall and the chafer.

19. The tire as set forth in claim 16 wherein the first apex and the second apex both contain a reinforcing material.

20. The tire as set forth in claim 16 wherein the inner stiffener member contains a reinforcing material.
